(19) United States
(12) Patent Application Publication
(10) Pub. No.: US 2012/0136700 A1
(43) Pub. Date: May 31, 2012

(54) SYSTEM AND METHOD FOR PERSONALIZED PRINTING AND FACILITATED DELIVERY OF PERSONALIZED CAMPAIGN ITEMS

(75) Inventor: Nick Evevsky, Webster, NY (US)

(73) Assignee: Xerox Corporation, Norwalk, CT (US)

(21) Appl. No.: 13/366,488

(22) Filed: Feb. 6, 2012

Related U.S. Application Data
(63) Continuation of application No. 12/138,510, filed on Jun. 13, 2008.

(51) Int. Cl. G06Q 30/02

(52) U.S. Cl. 705/14.4

(57) ABSTRACT

A system, having a corresponding method, for personalized campaign printing and delivery of a printed campaign includes: a processor that stores and processes printing and delivery data and selects printers to execute the printing and shipping of campaign items requested by a plurality of users designing separate personalized campaign items and accumulates, combines and splits the incoming data into at least one batch of items segmented into an air or ground shipping method; splits the batch into at least one smaller batch segmented by shipping code; and determines whether the batch qualifies for a discounted shipping rate. If no, the processor combines the batch with at least another regional batch of the same shipping method into a succeeding larger batch with a shipping code linked to the shipping code of the batch wherein the resulting combined batch qualifies for discounted shipping rate.

### CROSS REFERENCE TO RELATED APPLICATION

This application is a continuation of U.S. patent application Ser. No. 12/138,510, filed on Jun. 13, 2008, from which priority is claimed, the disclosure of which is hereby incorporated by reference in its entirety.

### BACKGROUND

1. Technical Field

The present disclosure relates to printing and shipping of printed material, and in particular, to systems and methods of printing and shipping personalized printed material.

2. Description of Related Art

In an advertising marketing campaign, typically printed collaterals are sent that are then mailed to end customers. Per customer, the total cost of delivering this printed collateral to a specific end user is higher than it could otherwise be because processing a single campaign job is usually implemented by a single print shop. Per customer, the cost of postage is not usually discounted as much as possible because the print shop is physically a long distance from the postal destination. In addition, the quantity of the mailing does not enable discount on postage because such types of discounts require a minimum volume per postal (or zip) code that usually cannot be met to qualify for the maximum postal discounts.

During advertising marketing campaigns, collaterals are printed and mailed to end customers. The printed collaterals are usually processed by a single print shop. Since a single print shop is usually physically distant from the end user shipping or postal destination, the cost of postage or shipping is usually not discounted as much as would otherwise be possible if the print shop were located physically close to all of the end shipping or postal destinations.

Systems and methods are known in the art to match publishers to printers for particular print jobs to reduce mail processing and distribution costs, or expedite mail distribution.

However, the quantity of the printed collaterals usually does not qualify for a shipping or postal discount because, for example, to qualify for such discounts, a minimum volume per postal code is required. Thus, on a per customer basis, the total cost of delivering printed collaterals to a specific end-user often cannot be reduced by qualifying for shipping or postal quantity discounts.

### SUMMARY

The present disclosure relates to a system for personalized printing and delivery of a printed campaign enables more energy efficient printing of the printed campaign, and thus a reduced carbon footprint, due to the increase in utilization of printers local to the end customer as compared to the prior art, due to the more precise identification of shipping destinations by shipping code and segmenting of the batches according to the multiple levels of discounted shipping rates available.

The system according to the present disclosure also reduces, for personalized printing and delivery of a printed campaign, the printing and shipping costs proportionally for smaller customers.

Correspondingly, the present disclosure relates to a method of personalized campaign printing and delivery of a printed campaign that also enables more energy efficient printing of the printed campaign, and thus a reduced carbon footprint, due to the increase in utilization of local printers as compared to the prior art, due to the more precise identification of shipping destinations by shipping code and segmenting of the batches according to the multiple levels of discounted shipping rates available.

Thereby, the method according to the present disclosure also reduces, for personalized printing and delivery of a printed campaign, the printing and shipping costs proportionally for smaller customers.

As a result, according to aspects illustrated herein, there is provided a system for personalized campaign printing and delivery of a printed campaign, wherein the system includes: a processor configured to store and process printing and delivery data enabling facilitation of delivery of the printed campaign, wherein the processor is at least one of: configured to receive the printing and delivery data from a plurality of users designing separate personalized campaign items, wherein the data includes incoming data from at least one of the plurality of users designing personalized campaign items requesting printing and delivery of a plurality of personalized campaign items to a plurality of end recipients; configured to receive the printing and delivery data from a plurality of users performing printing functions to print and ship a plurality of the separate personalized campaign items to the plurality of end recipients; and configured to receive the printing and delivery data from a plurality of users performing transporting functions to deliver at least one of the plurality of personalized campaign items to a plurality of end recipients; and a network configured to enable communication at least one of: amongst the processor, the plurality of users performing advertising functions and designing the separate personalized campaign items, the plurality of users performing printing functions to print and ship a plurality of the separate personalized campaign items; between the processor and the plurality of users designing the separate personalized campaign items; and between the processor and the plurality of users performing printing functions to print and ship a plurality of the separate personalized campaign items, wherein the processor stores and processes printing and delivery data wherein the processor selects at least one of the plurality of users performing printing functions to execute the printing and shipping of the plurality of personalized campaign items and wherein the processor signals instructions to: accumulate the incoming data; combine the incoming data; split the incoming data into at least one batch of personalized campaign items segmented by at least one of a ground shipping method designated for the at least one batch and an air shipping method designated for the at least one batch; split the at least one batch segmented by at least one of a ground shipping method and an air shipping method into at least one smaller batch segmented by shipping code; and determine whether the at least one batch is of the minimum size to qualify for a discounted shipping rate, wherein if no, the processor signals instructions to combine the at least one batch with at least another regional batch of the same shipping method into a succeeding larger batch wherein the at least another regional batch has a shipping code that is linked to the shipping code of the at least one batch wherein the resulting combined batch qualifies for a discounted shipping rate.

One disclosed feature of the embodiments is a system for personalized campaign printing and delivery of a printed campaign wherein the system includes: a processor configured to store and process printing and delivery data enabling optimization of delivery of the printed campaign; wherein the processor is at least one of; configured to receive the printing and delivery data from a plurality of users designing separate personalized campaign items, wherein the data includes incoming data from at least one of the plurality of users designing personalized campaign items requesting printing and delivery of a plurality of personalized campaign items to plurality of end recipients; configured to receive the printing and delivery data from a plurality of users performing printing functions to print and ship a plurality of the separate personalized campaign items to the plurality of end recipients; and configured to receive the printing and delivery data from a plurality of users performing transporting functions to deliver at least one of the plurality of personalized campaign items to a plurality of end recipients; and a network configured to enable communication at least one of: amongst the processor, the plurality of users designing the separate personalized campaign items, the plurality of users performing printing functions to print and ship a plurality of the separate personalized campaign items; and between the processor and the plurality of users designing the separate personalized campaign items; and between the processor and the plurality of users performing printing functions to print and ship a plurality of the separate personalized campaign items, wherein the processor stores and processes printing and delivery data wherein the processor selects at least one of the plurality of users performing printing functions to execute the printing and shipping of the plurality of personalized campaign items and wherein the processor signals instructions to: accumulate the incoming data; combine the incoming data; split the incoming data into at least one batch of personalized campaign items segmented by at least one of a ground shipping method designated for the at least one batch and an air shipping method designated for the at least one batch; and wherein the processor signals instructions to at least one of: calculate a carbon footprint of at least one personalized campaign item by at least one of: calculating a printing energy footprint to print the at least one of the plurality of personalized campaign items; and calculating a shipping energy footprint to ship the at least one of the plurality of personalized campaign items; and calculate a carbon footprint of at least one personalized campaign item by: calculating a printing energy footprint to print the at least one of the plurality of personalized campaign items; calculating a shipping energy footprint to ship the at least one of the plurality of personalized campaign items; and adding the printing energy footprint to the shipping energy footprint to obtain the carbon footprint of the at least one of the plurality of personalized campaign items.

Additionally, according to aspects illustrated herein, there is provided a method of personalized campaign printing and delivery of a printed campaign, the method including: interconnecting, via a network, a plurality of users performing advertising functions and designing separate personalized campaign items for shipping to a plurality of end recipients; storing and processing printing and delivery data enabling delivery of the printed campaign wherein the data includes incoming data from at least one of the plurality of users performing advertising functions and designing personalized campaign items requesting printing and delivery of at least one personalized campaign item to a plurality of end recipients; accumulating the incoming data; combining the incoming data; splitting the incoming data into at least one batch of personalized campaign items segmented by at least one of a ground shipping method designated for the at least one batch and an air shipping method designated for the at least one batch; splitting the at least one batch segmented by at least one of a ground shipping method and an air shipping method into at least one smaller batch segmented by shipping code; and determining whether at least one batch is of the minimum size to qualify for a discounted shipping rate, wherein if no, combining the at least one batch with at least another regional batch of the same shipping method into a succeeding larger batch wherein the at least another regional batch has a shipping code that is linked to the shipping code of the at least one batch wherein the resulting combined batch qualifies for a discounted shipping rate.

### BRIEF DESCRIPTION OF THE DRAWINGS

These and other advantages will become more apparent from the following detailed description of the various embodiments of the present disclosure with reference to the drawings wherein:

FIG. 1 is a block diagram of one embodiment of a system that can be used for printing a personalized campaign and optimizing and/or facilitating delivery of the printed campaign in accordance with the present disclosure;

FIG. 2 is a block diagram illustrating one embodiment of a method of acquiring customers during implementation of a method of printing a personalized campaign and optimizing and/or facilitating delivery of the printed campaign in accordance with the present disclosure;

FIG. 3 is a block diagram illustrating one embodiment of a method of submitting printing campaigns during implementation of a method of printing a personalized campaign and optimizing and/or facilitating delivery of the printed campaign in accordance with the present disclosure;

FIG. 4 is a block diagram illustrating one embodiment of a method of merging and segmenting printing campaigns during implementation of a method of printing a personalized campaign and optimizing and/or facilitating delivery of the printed campaign in accordance with the present disclosure;

FIG. 4A is a continuation of the block diagram of FIG. 4;

FIG. 4B is another continuation of the block diagram of FIG. 4;

FIG. 5 is a block diagram illustrating one embodiment of a method of bidding for and fulfilling printing campaigns during implementation of a method of printing a personalized campaign and optimizing and/or facilitating delivery of the printed campaign in accordance with the present disclosure;

FIG. 6 is a block diagram illustrating one embodiment of a method of acquiring a plurality of users performing printing functions during implementation of a method of printing a personalized campaign and optimizing and/or facilitating delivery of the printed campaign in accordance with the present disclosure;

FIG. 7 is a block diagram illustrating one embodiment of a method of quantifying a carbon footprint and optionally applying a green or energy logo during implementation of a method of printing a personalized campaign and optimizing and/or facilitating delivery of the printed campaign in accordance with the present disclosure;

FIG. 8 is a block diagram illustrating one embodiment of a method of implementing quality assurance during implementation of a method of printing a personalized campaign and optimizing and/or facilitating delivery of the printed campaign in accordance with the present disclosure;

FIG. 9 is a detailed view of a first side of a campaign item that appears in FIG. 1 and which displays an energy or green logo according to the present disclosure; and

FIG. 10 is a detailed view of a second side of the campaign item of FIG. 9 and which displays an energy or green logo according to the present disclosure.

### DETAILED DESCRIPTION

The present disclosure relates to a system for personalized campaign printing and delivery of a printed campaign and methods for printing of personal campaigns and delivery of the campaign. Specifically, embodiments of the present disclosure enable lowering of the average cost of delivering to an end user printed collaterals for a personalized marketing campaign by combining the print volume of multiple sources, such as advertising agency campaigns, and then segmenting on a regional or local basis the total print volume to multiple print shops. The multiple print shops compete for individual segments of print volume and to provide reduced shipping costs in a reverse auction format.

In addition to reduced printing costs, because the print shops awarded the contract to perform the printing and shipping functions tend to be physically closer to the destination of the end recipient, the embodiments of the present disclosure enable further reductions in shipping costs by qualifying for minimum batch discounts on the basis of achieving minimum batch size. Additionally, the embodiments of the present disclosure enable applying of an energy or green logo to the individual printed collateral, e.g., to each individual campaign card that is shipped on the basis of meeting criteria that are indicative of categorization of the energy or carbon footprint of the individual campaign card that is shipped.

The following terms are defined herein as background information and may or may not appear in the remainder of the present disclosure:
Shipping code—a number that is designated for a locality of a shipping point or a locality of an end recipient of a printing campaign. A shipping code can be further segmented and designated for a portion of a locality of a shipping point or a locality of an end recipient. An example of a shipping code is a US zip code.
Zip Code or Postal Code—a number that is designated for a subset of a state or province corresponding to a locality of a shipping point or a locality of an end recipient of a printing campaign. The United States (US) is segmented in the following ways, from finest to coarsest, according to the US Postal Service (USPS):
   Proximity—refers to the distance between a printer and the destination address of an end recipient. Even though a piece of mail can be sorted in the ways described above, generally the closer the piece of mail is submitted to the shipper in relation to its final zip code, the less expensive the shipping will be.
   Delivery Date Range—is the range of dates within which the document must be delivered. Wider latitude in the date range yields more delivery possibilities and possibly a reduced shipping price, such as using alternatives to First Class mail.

Reverse Auction—is a process wherein the bidding decreases in price over time and the lowest bidder wins at the end of the auction.

Advertising Agencies—are customers who create and send out individual mailers to multiple, but separate, end-customers. An advertising agency may include a customer with a comparatively small volume and that produces media other than mail.

Optimization System—a web-based or internet-based system that accepts orders, segments and auctions the print work, and manages billing and payments. The optimization system is referred to herein as a processor. The processor may also be defined as a facilitation system that facilitates the web-based or internet-based system that accepts orders, segments and auctions the print work, and manages billing and payments.

Printing Companies—are the multiple printing companies that bid on available print and mailing work, e.g., a personalized campaign print job.

Printers—are the apparatuses, that may be driven by local processors, that are utilized by the printing companies to fulfill print orders. More particularly, the word or term printer as used herein encompasses any apparatus, such as a digital copier, bookmaking machine, facsimile machine, multi-function machine, etc. which performs a print outputting function for any purpose. The term printer as used herein may also refer to a person or a group of persons representing a printing company that bid on available print and mailing work.

Shipping Office—is an alternative location where the final mailers or batches may be sent to be delivered to the end user or recipient. An example of this could be the US Post Office.

Delivery—is the process of transporting the item from a printing company to the end-customer

Mailer—is an individually printed document, campaign item, or campaign post card that is sent to each end-customer.

Final Location—is the delivery address or destination for the end-customer recipient.

End Customer(s) or recipient(s)—is/are the person or persons to whom the mailer is sent and by whom the mailer or campaign item is intended to be read.

Job—is a collection of shipped printed material that is destined for a specific area such as a state or zip code. A job is the unit of work that different printers would bid on and then fulfill if they are the winning bidder.

Document Mapping—within a campaign multiple possible combinations of graphics and text could be included within the campaign, e.g., graphics of different models of cars along with different messages. Document mapping is enabled by extra information included within the database of end user locations that would also specify which graphics and corresponding text each card would be assembled with.

The following description is a general example of implementation of the printing and delivery method according to the present disclosure, based on shipping codes that are postal zip codes and wherein the shipping office is the United States Postal Service:

Sign Up(s)—Before the process begins, the customer and printing companies register to use this service. Other than the basic information gathered, the printing companies also supply the shipping code or Post Office Delivery Postal Codes for each Mail Printing/Sorting location they plan to deliver mail to.

### Accept Campaigns

An accept campaign event occurs when an Advertising Agency adds a Campaign Job to be fulfilled. The advertising agency supplies the specifications of what to print including the following data:
the database of delivery locations and corresponding mapping specification
the maximum campaign package price
the delivery date range within which the End-Customers must receive their personalized mailing
a list of any printing companies excluded from the auction
whether a green logo is required
an optional constraint of the maximum energy per card to be expended
   View and Bid on available Jobs during Auction Period

A single job that is presented to two different printers that are in different parts of the country see different shipping cost information presented. For example, a printer in California seeing the job for 3-digit (California) zip code 902 will see a lower average shipping price on their computer display than a printer in New York. Thus the printers that are in closer proximity to the most end destinations for the campaign items tend to bid lower since their shipping costs will be lower for a particular job.

An individualized bidding portal presents the available work per postal area as follows on a per Job basis.
The highest level lists all 3-digit zip codes, the total number of campaign items, and lowest possible calculated average mailing cost per item and maximum price if using first class mail or equivalent.
If the quantity is not sufficient, multiple 3-digit zip codes are combined.
The lower levels drill down the 3-digit jobs into multiple 5-digit zip code.
   Other possible discounted shipping rates are noted that might require extra work steps.

The auction period is when the print shops can start bidding on one or more jobs.
After each printer has located their jobs of interest, each printer can bid their lowest possible price.
   The printer can filter out agencies that they do not wish to do business with.
Printers bidding on one or more jobs with the following constraints:
   The bids cannot exceed the maximum bid price
   After a bid is placed, lower bids may be placed by competitive printers until the end of auction
If there is bidding within a pre-determined time period before the expiration time of the bidding period, the expiration time of the auction may be extended by a desired amount of time.

### Fulfill and Deliver Jobs

At the end of the auction time period, all of the separate print jobs that can be printed together may be combined and then segmented in the following hierarchy.
By Print Type—for example, double sided 3″ by 5″ cards, double sided 4″ by 6″ cards, etc.
By 3-Digit Zip Code
   By 5-Digit Zip Code
      By Carrier Neighborhood
      By Delivery Date Range

The resulting combination and segmentation is a data structure that contains the hierarchy of print volume information for each 3-digit zip code area.

Next, per 3-digit zip code, the lowest possible shipping costs are calculated on a per (competing) printer basis.

### Job Printing and Fulfillment

Each job is potentially broken up and printed to gain best discounted shipping rates and the configuration is logged into the system.
One or more post office payment invoices is created and printed.
The combined job(s) and prepared invoice(s) are sent to the post office and mailed to all of the individual customers.

### Billing, Invoicing, and Promotions

The customer is billed for the work completed plus an additional commission to use the service.
   The invoice includes a report that lists which printing company printed each mailer and average delivery miles per mailer.
   Possible discounts can be offered for volumes and level of relationship with the system provider.
   Possible discounts can be offered for allowing a logo of the system provider and/or website address of the system provider to be added to the campaign deliverables.
The Printer is paid for work completed minus a commission to use this service for all jobs.
   The payment includes a report that lists which agency requested each mailer.
The shippers are paid for work completed minus any volume commissions.
   The payment includes a report that usage for that billing period.

### Quality Assurance

To validate that the printers are sending out the campaign print job(s) which they accepted by bidding upon and that the quality of the campaign print job(s) meets specifications, the following optional steps may be taken:
   A test mailing per delivery printer job is mailed to a campaign quality verification facility. Along with an image test pattern, the collateral will include a digital mark that will encode the campaign data so that the item can be scanned and the data added to the campaign record. Over time, once a quality baseline has been established, the frequency of these additional mailings can be reduced to a statistically appropriate level.

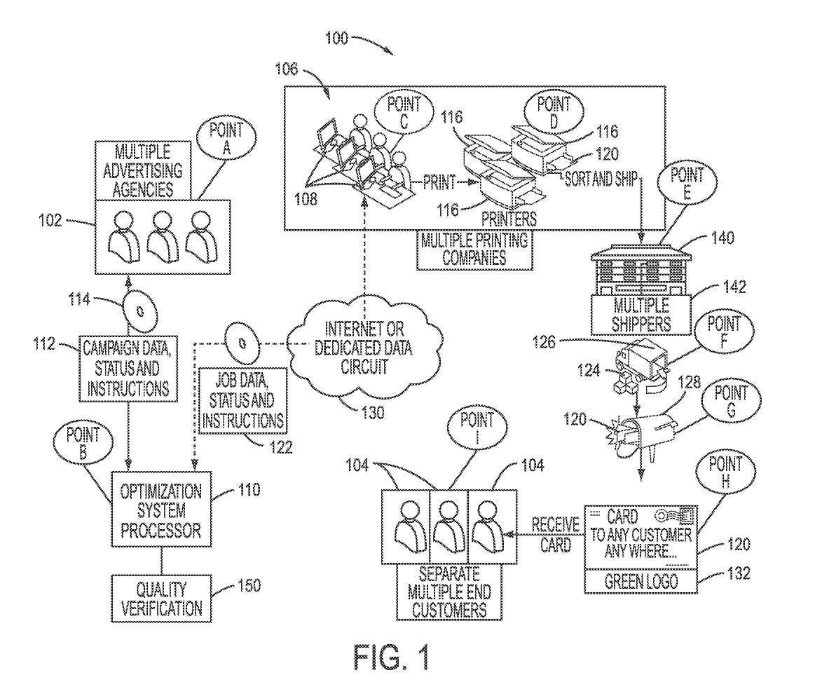

Referring now to the figures, FIG. 1 is a block diagram of a system 100 that can be used for printing a personalized campaign and optimizing and/or facilitating delivery of the printed campaign in accordance with the present disclosure. More particularly, a plurality of customers or system users 102 that may be multiple advertising agencies at Point A perform advertising functions and/or design separate personalized campaign items 120 (at Points C and D described below) for shipping to a plurality of end recipients or multiple end customers 104 at Point I. A card is shown in FIG. 1 as an example of campaign item 120. As defined herein, a user or users is/are one or more persons, or one or more organizations, e.g., an advertising agency that executes a campaign of advertising to create and produce advertising material as defined hereinafter. In such a situation, the advertising agency acts as an agent for the ultimate beneficiary of the advertising campaign, i.e., the end client. A user or users may also be the end client who would directly request execution of the advertising campaign without going through an advertising agency and is the ultimate beneficiary. Advertising functions are defined herein as tasks or actions relating to the dissemination of information pertaining to products, goods or services, particularly products, goods or services provided by a user or users. Advertising is defined as the act of calling something to the attention of the public, particularly by paid announcements. The plurality of system users 102 generate personalized campaign data 112 that may include data on status of the campaign data 112 and/or instructions regarding the campaign data 112. As defined herein, the term personalized refers to an action performed to make the campaign data 112 pertain to a particular individual, thereby making the campaign data 112 personal or individual. It should be noted that, as related to the present disclosure, such actions may not necessarily be limited to one particular individual but may apply to identical or substantially similar actions that pertain to more than one particular individual. Also as defined herein, campaign data refers to information relating to implementation of the system 100 to print a personalized campaign and/or facilitate delivery of the printed campaign in accordance with the present disclosure. A campaign as defined herein is a connected series of operations designed to bring about a particular result. More particularly, as related to the present disclosure, a campaign generally relates to the process of disseminating personalized information intended to persuade an end recipient of such information to take a particular action to acquire, purchase, lease, hire, or the like, the products and/or goods and/or services provided by a user or users. Such products, and/or goods and/or services may be in the form of samples thereof or notification of availability of services on a sample basis. As defined herein, reference to separate personalized campaign items refers to one campaign item 120 out of the plurality of campaign items that, when considered as a group formed by the plurality of personalized campaign items are substantially similar to each other, but when considered individually are different from each other due to particular distinguishing differences related to the separate individuals forming the plurality of end recipients 104 of the separate campaign item 120.

At least one processor 110 is disposed in the system 100 at Point B to store and process printing and delivery data, thereby enabling optimization and/or facilitation of delivery of the printed campaign. Although it is contemplated that the processor 110 is a machine, it is also contemplated that the functions performed by the processor 110 may be performed manually by one or more human beings or by machine assistance to one or more human beings. Thus, as defined herein, reference to a processor includes a machine or one or more human beings or machine assistance to one or more human beings. The data includes incoming data from at least one of the plurality of users 102 that perform advertising functions and/or design the personalized campaign cards 120. A suitable network connection 114 is established between the at least one of the plurality of users 102 at Point A and the processor 110 at Point B. The plurality of users 102 request printing and delivery of a plurality of the personalized campaign cards 120 to the plurality of end recipients 104.

A plurality of users 106 perform printing functions to print and ship a plurality of the separate personalized campaign cards 120 to the plurality of end recipients 104. For simplicity, the plurality of users 106 that perform printing functions to print and ship a plurality of the separate personalized campaign cards 120 may also be referred to as one or more printers 106. The processor 110 is at least one of: configured to receive the printing and delivery data from the plurality of users 102 designing separate personalized campaign items 120, wherein the data includes incoming data from at least one of the plurality of users 102 designing personalized campaign items 120 requesting printing and delivery of a plurality of personalized campaign items 120 to a plurality of end recipients 104; configured to receive the printing and delivery data from a plurality of users performing printing functions 106 to print and ship a plurality of the separate personalized campaign items 120 to the plurality of end recipients 104; and configured to receive the printing and delivery data, as explained in more detail below, from a plurality of users performing transporting functions 142 to deliver at least one of the plurality of personalized campaign items 120 to a plurality of end recipients 104.

A network 130 is configured to enable communication amongst the processor 110, the plurality of users 102 performing the advertising functions and/or designing the separate personalized campaign cards 120, and the plurality of users 106 performing printing functions to print and ship a plurality of the separate personalized campaign cards 120, or at least between the processor 110 and the the plurality of users 102 performing the advertising functions and/or designing the separate personalized campaign cards 120, or at least between the processor 110 and the plurality of users 106 performing printing functions to print and ship a plurality of the separate personalized campaign cards 120. The network 130 may include a telephone system network enabling at least voice communication amongst the aforementioned users and/or a web-based and/or local area network enabling communication amongst processors such as processor 110.

The processor 110 stores and processes the campaign data 112 and also stores and processes print job data 122 that includes printing and delivery data and status and/or instructions related to the personalized printing campaign. The print job data 122 is communicated via the network 130 between the processor 110 and the plurality of users 106 performing printing functions. The processor 110 also selects at least one of the plurality of users 106 performing printing functions to execute the printing and shipping of a plurality of the personalized campaign cards 120.

The processor 110 also accumulates the incoming campaign data 112 that is to be converted into a campaign print job and combines the incoming data 112 as is discussed in more detail below.

The plurality of users 106 performing printing functions each interact with the processor 130 to receive and transmit print job data 122. The plurality of users 106 may execute the print job via one or more local processors 108 at Point C. The one or more local processors 108 may execute print instructions to one or more printers 116 at Point D to print and sort the print job into a portion of the final campaign delivered to the plurality of end recipients 104. Following the sorting process, which is discussed in more detail below, the portion of the final campaign that is executed by a particular local printer 106 is delivered to one or more shipping facilities 140 at Point E, e.g, multiple post offices or shipping service provider facilities wherein at least one of a plurality of users performing transporting functions, e.g., multiple shippers 142, deliver at least one of the plurality of personalized campaign items 120 to at least one of the plurality of end recipients 104.

Although the one or more shipping facilities 140 or their operators, multiple shippers 142, are not directly registered as users within the optimization system 100, the processor 110 may be configured to monitor shipping operator shipping data, when available, once custody of the particular portion of the printed campaign has been transferred to the particular shipping operator for delivery of the separate personalized printed campaign cards 120 to the plurality of end recipients 104 at Point I.

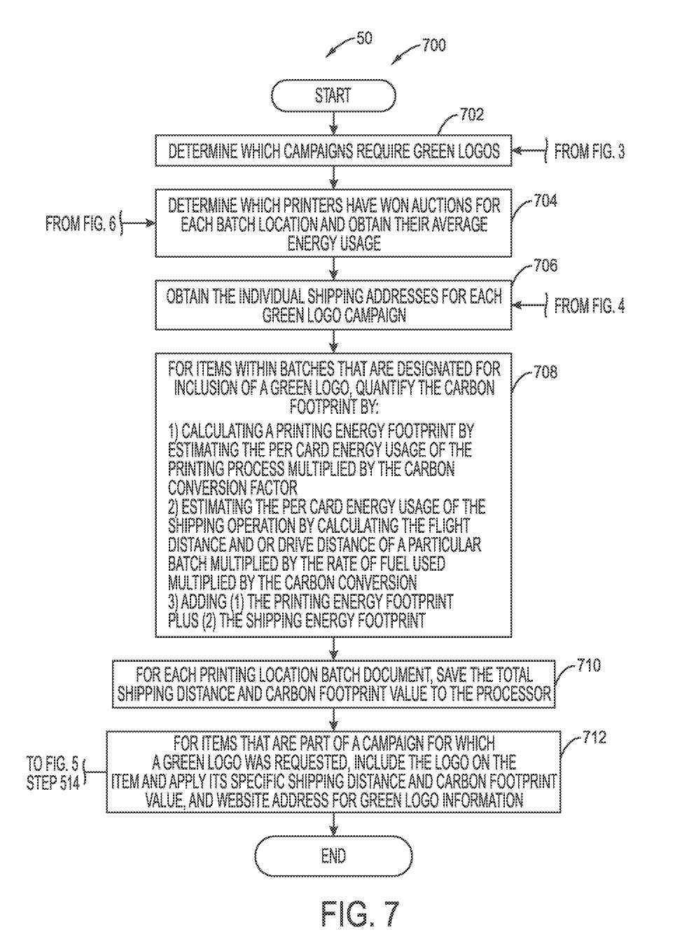

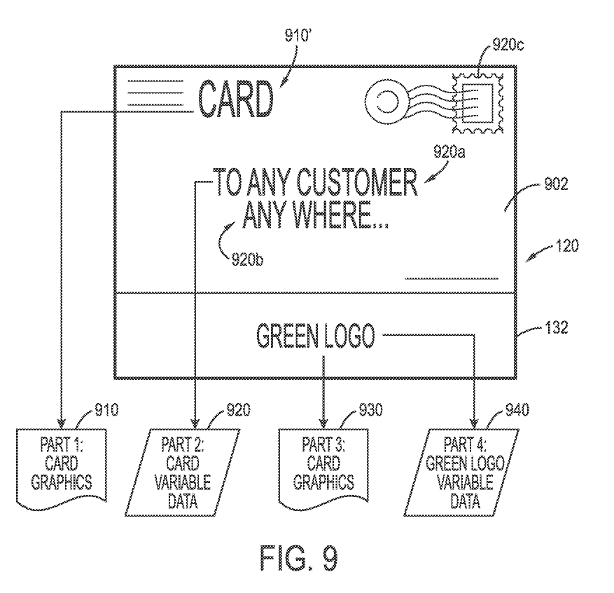

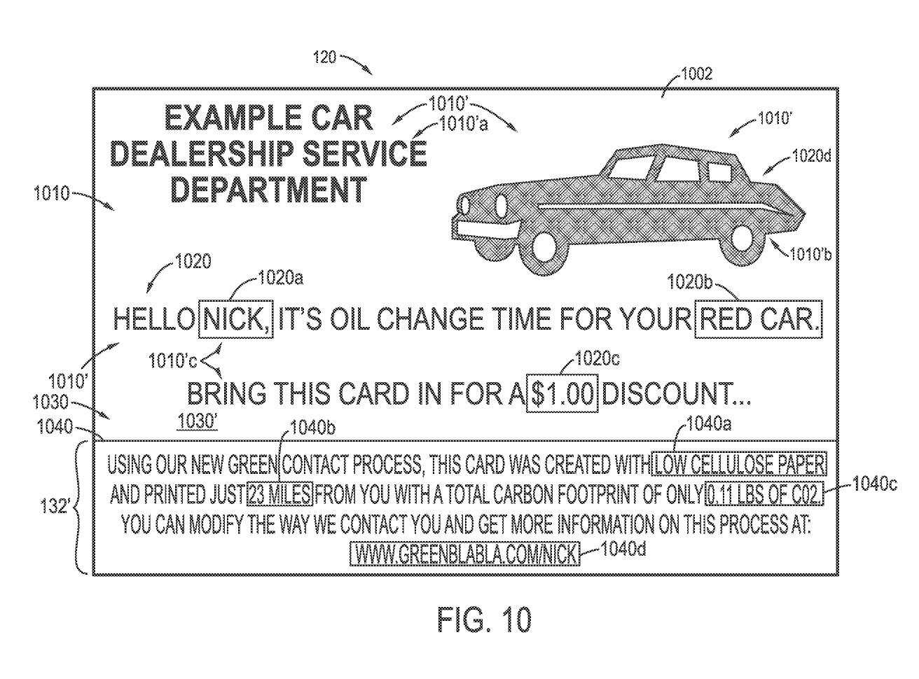

As explained in more detail below, the particular portion of the printed campaign, after having been combined by one of the plurality of users 106 performing printing functions, is split into separate batches 124 based on shipping code. The separate batches 124 of personalized campaign cards 120 are shipped by the operator of the shipping facilities 140 via the most cost-effective available means of transportation at Point F, e.g., by truck 126, as shown, or by air, rail or marine vehicle (none of which are shown). The personalized campaign cards 120 are then shipped to an end recipient receiving facility 128 at Point G, e.g., a receiving mail box, as shown, or a house or apartment building, a store, business or business facility or building of a commercial or non-profit nature, etc., none of which is shown, for delivery to an end recipient 104 at Point I. Also as explained in more detail below with respect to FIG. 7, an energy or green logo 132 may be applied to some or all of the personalized campaign cards 120 that reflects the amount of energy used in implementing the printing and shipping process by one or more of the printers 106. Details of the energy or green logo 132 (and a related energy or green logo 132′) are discussed below with respect to FIGS. 9 and 10.

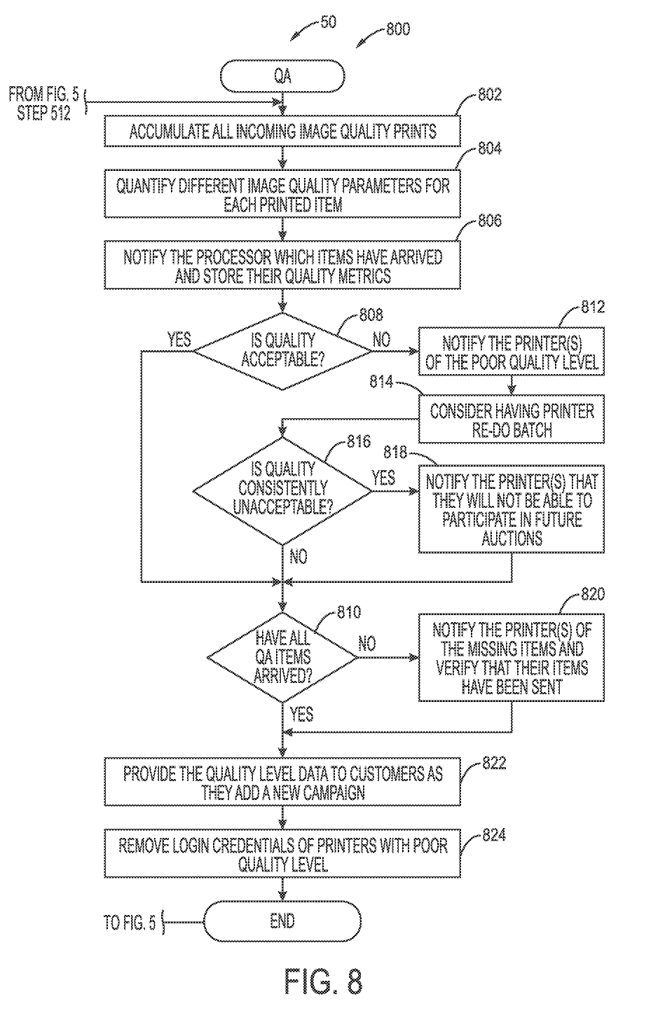

As described below with respect to FIG. 8, the system 100 may include a quality verification facility or processor 150. When implemented as a quality verification facility, quality verification facility 150 includes one or more human beings or persons who manually receive for review at least one quality image print from the printers 106 during the execution of a campaign print job. When implemented as a processor, quality verification processor 150 signals instructions to send at least one quality image print to the printers 106 during the execution of a campaign print job. The quality verification processor 150 may then signal instructions to retrieve or receive the quality image print(s) and review by scanning the print for quality acceptability. The quality verification processor 150 may be an independent processor in electrical communication with the optimization processor 110. Alternatively, the functions of the quality verification processor 150 may be performed by a single integrated optimization system processor 110.

In one embodiment, the shipping code is a postal code, e.g., a postal zip code as prescribed by the United States Postal Service. The breakdown of zip code as follows:
By 3-Digit ZIP Code, e.g., 123_{—}
   By 5-digit zip code, e.g., 12345
      By Carrier Neighborhood e.g., 12345-6789
      By Delivery Date Range e.g., June 6 to Jun. 12, 2007
   By Class: e.g., Standard or Not-For-Profit
      The result is a data structure that contains the hierarchy of print volume information for each 3-digit zip code area.

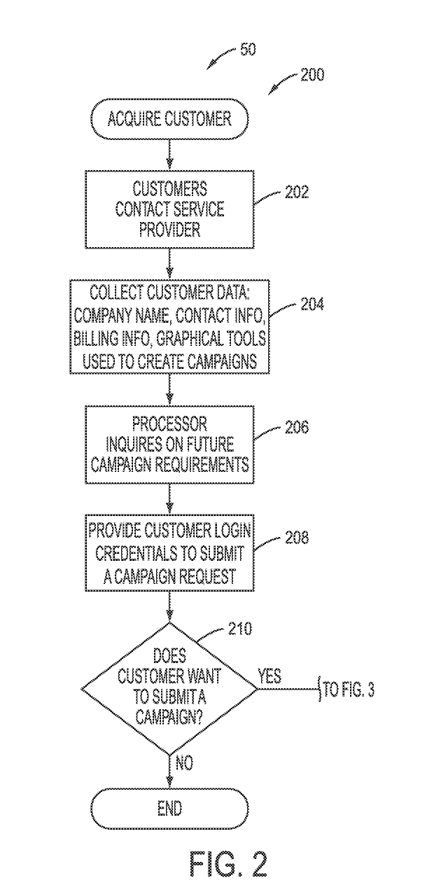

Referring now to FIG. 2, there is illustrated one embodiment of a method 200 of acquiring customers during implementation of an overall method 50 of printing a personalized campaign and optimizing and/or facilitating shipping/delivery of the printed campaign in accordance with the system 100 of FIG. 1 as previously described with respect to the present disclosure. More particularly, in conjunction with the system 100, method 200 includes a step 202 wherein the plurality of customers or system users 102 that may be multiple advertising agencies contact a service provider (not shown in FIG. 1), e.g., an operator of the optimization system processor 110. In step 204, the service provider collects data regarding a customer 102. Such data may include the name of the customer's company, the contact information, billing information, and a description of the type of graphical tools which the customer 102 uses to create a campaign.

In step 206, once the customer data has been established in step 204 and a suitable network connection established between the customer 102 and the processor 110, e.g., network connection 114 between Point A and Point B, the processor 110 inquires on future campaign requirements by the customer 102.

In step 208, the processor 110 provides customer login credentials to the customer 102 in order to enable the customer 102 to submit a campaign request or job order.

In decision step 210, the customer 102 is queried as to whether the customer 102 wants to submit a campaign request or job order. If no, the method 200 ends.

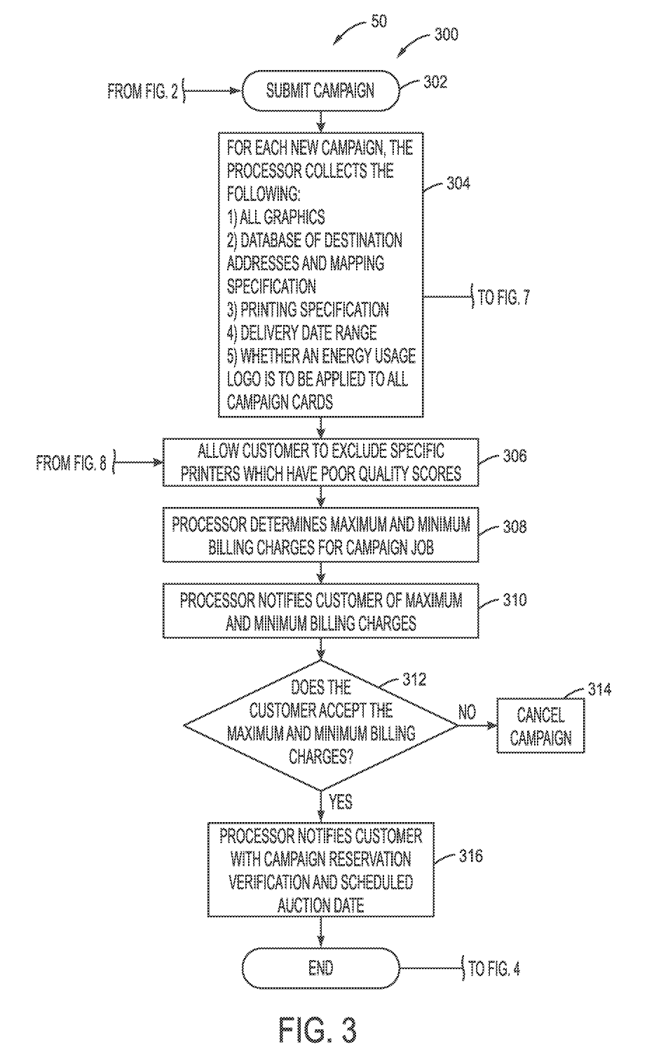

If yes, the method 50 transfers to FIG. 3 which illustrates one embodiment of a method 300 of submitting printing campaigns during implementation of the method 50 of printing a personalized campaign and optimizing and/or facilitating shipment/delivery of the printed campaign in accordance with the present disclosure.

In step 302, the customer 102 submits a campaign request or job order. In step 304, the customer 102 authenticates on the system 100 via implementation of the login credentials. Step 304 further includes, for each new campaign request or job order added by the customer 102, the processor 110 collecting the following information:

1) All graphic materials applicable to the personalized campaign card to be delivered to the end recipient 104;

2) A database of end recipient destination addresses and a specification of document mapping as described above;

3) A printing specification;

4) A desired range of delivery dates for the campaign request or job order; and

5) Whether an energy usage (green) logo 132 is to be applied to all campaign cards 120. If yes, the method 300 transfers to FIG. 7, described below with respect to the energy calculations for applying the green logo 132.

Following completion of step 304, in step 306, either the customer 102 manually excludes specific printers 106 which have poor quality scores or the processor 110 allows one or more customers 102 to exclude specific printers 106 which have poor quality scores based on qualifications and/or past performance. Exclusion step 306 is enabled as a result of a process described in FIG. 8 below. Hence, exclusion step 306 is a transfer step from FIG. 8.

In step 308, the processor 110 determines the maximum and minimum billing charges for the campaign job. More particularly, the processor 110 calculates a quotation of expected pricing by using historic price data and the present range of shipping costs for the particular class or category of campaign item 120. For example, the campaign item 120 may be exemplified by a (1) 3 inch (7.6 centimeter) by 5 inch (12.7 centimeter) full color card or highlight color card; or by a (2) 4 inch (10.1 centimeter) by 6 inch (15.2 centimeter) full color card or highlight color card; or by a (3) black and white card of either size and having a single color. The foregoing classes or categories of campaign items 120 are not intended to be limited thereto and other campaign items may fall within the scope of the present disclosure. For example, campaign items 120, as applied to execution of the method 50 and operation of the system 100 (see FIG. 1) may include, but are not limited to, booklets, leaflets, documents, or even non-printed items such as manufactured products or goods including cartons, containers, paper, plastic, metallic goods or products or liquid or gaseous materials contained therein, tools, gadgets, souvenirs, toys, charms and the like. The embodiments are not limited in this context.

First, printing data is queried from recent history data, as follows:

1. Lowest printing cost;

2. Most likely (average) historical printing cost; and

3. Highest printing cost.

Next, shipping data is prepared based on present day shipping costs, as follows (based on the United States Postal Service rates as an example):

A. Lowest bulk rate postage or shipping charges available;

B. Most likely historical shipping cost;

C. Highest first class postage or shipping charges available.

The above data are combined to generate a per item cost range, as follows:

Minimum cost=1+A

Typical cost=2+B

Maximum cost=3+C

The price range (Minimum, Typical or Average, and Maximum) is scaled by the number of items in the campaign for the total expected price range. The processor 110 combines the historic printing data (1, 2, 3) and the shipping data estimates and determines the following:

Low to High price range per item and anticipated final cost; and

Low to High price range per campaign and anticipated final cost.

In step 310, the processor 110 notifies the customer of the maximum and minimum billing charges for the proposed campaign job. More particularly, the processor 110 notifies the customer of, for example, the Low to High price range per item and anticipated final cost; and of the Low to High price range per campaign and anticipated final cost.

In step 312, it is determined whether the customer accepts the maximum and minimum billing charges. More particularly, it is determined whether the customer accepts, for example, the Low to High price range per item and anticipated final cost; and the Low to High price range per campaign and anticipated final cost.

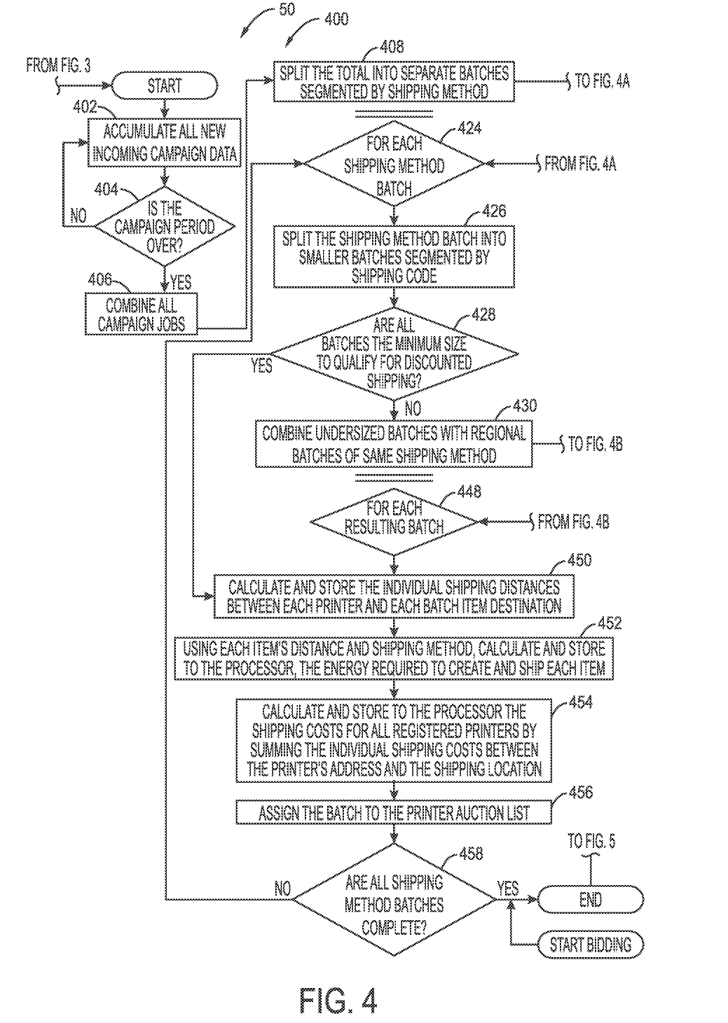

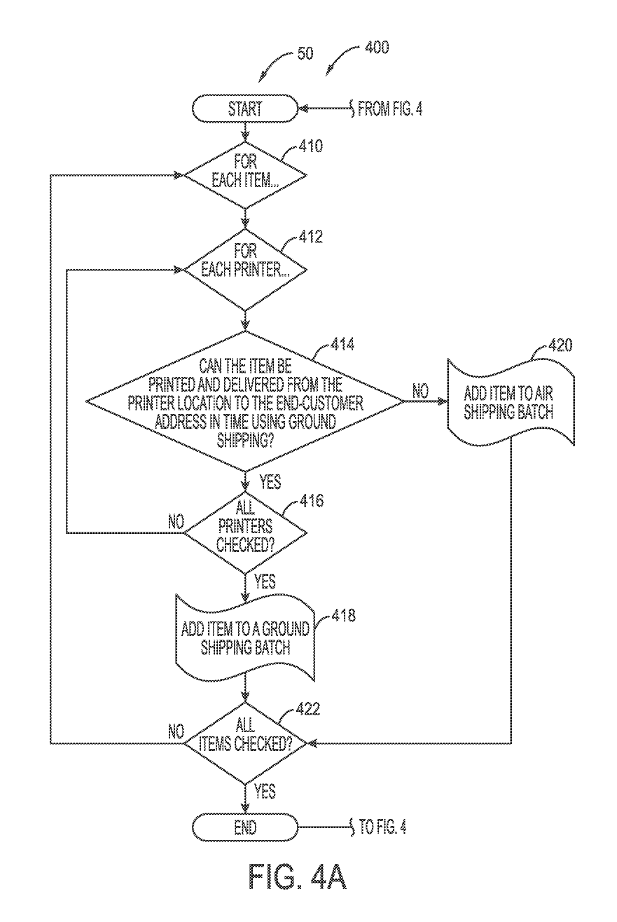

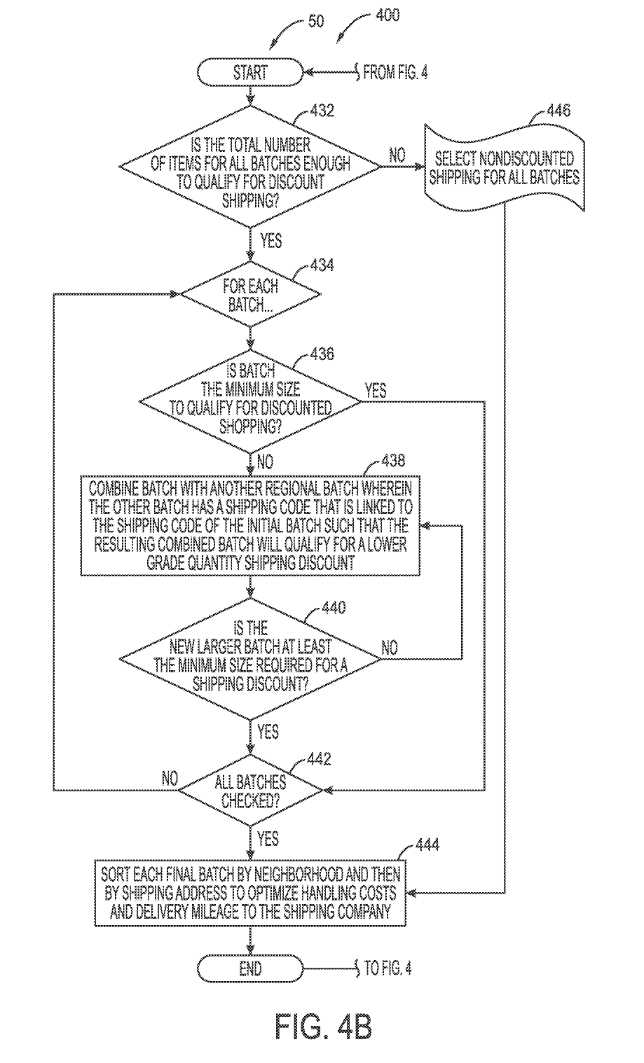

If no, step 314 is implemented of cancelling the campaign request and verifying deletion of any campaign information provided to the processor 110. If yes, step 316 is implemented wherein the processor 110 notifies the customer 102 with a campaign request or job order reservation verification and the scheduled date of an auction for the plurality of users 106 performing a printing function to bid on fulfilling the campaign request or job order. Implementation of the method 300 then transfers to FIG. 4.

FIG. 4 illustrates one embodiment of a method 400 of merging and segmenting printing campaigns during implementation of the method 50 of printing a personalized campaign and optimizing and/or facilitating shipping/delivery of the printed campaign in accordance with the present disclosure. More particularly, method 400 includes step 402 of accumulating all new incoming campaign data. Following step 402, in decision step 404, it is determined whether the campaign period is over. If yes, step 406 is implemented of combining all campaign jobs. If the campaign period is not over, the method 400 returns to step 402 of accumulating all new incoming campaign data until the campaign period is determined to be over, as per decision step 404, after which time step 406 is implemented of combining all campaign jobs. Following step 406, step 408 is implemented by splitting the total campaign job into separate batches segmented by shipping method.

Referring now to FIG. 4A, following step 408, method 400 is further implemented by joint implementation of steps 410, 412 and 414. Step 410 includes checking, for each printer as per step 412, whether the item, e.g., campaign card 120, can be printed and delivered from the printer location to the end-customer address in time using ground shipping, as per step 414, until it is determined as per step 416 that all printers have been checked. Once it has been determined in step 414 that for each printer, the item, e.g., campaign card 120, can be printed and delivered from the printer location to the end-customer address in time using ground shipping and it is determined that all printers have been checked, per step 416, step 418 is implemented of adding the item to a ground shipping batch, i.e., a batch that is to be shipped by ground transportation means, e.g., truck 126 in FIG. 1 (or by automobile or by train or by other surface transportation means, e.g., marine transport by boat, ship or ferry, etc., none of which are shown in FIG. 1).

If it is determined in step 414 that the item, e.g., campaign card 120, cannot be printed and delivered from the printer location to the end-customer address in time using ground shipping, step 420 is implemented of adding the item to an air shipping batch, i.e., a batch that is to be shipped by air transport.

If not all printers have been checked, step 412 is returned to wherein it is again determined in steps 412 and 414 for each printer whether the item, e.g., campaign card 120, can be printed and delivered from the printer location to the end-customer address in time using ground shipping until it has been determined as per step 416 that all printers have been checked. Once all printers have been checked, as per step 416, step 418 is implemented of adding the item to a ground shipping batch. In step 422, it is determined whether all items have been checked. If all items have not been checked, either manually or by the processor 110, step 410 is again implemented of checking each item in conjunction with steps 412 and 414 as described above. If all items have been checked, either manually or by the processor 110, implementation of the method 400 then transfers back to FIG. 4.

Referring again to FIG. 4, following step 422, step 424 designates for each batch, in conjunction with step 426 splitting the shipping method batch, e.g., a batch that is designated for ground shipping or a batch that is designated for air shipping, into separate batches that are segmented by shipping code. In decision step 428, it is determined whether the batch is the minimum size to qualify for discounted shipping. If the batch is not the minimum size to qualify for discounted shipping, i.e., the batch is an undersized batch with respect to qualifying for a discounted shipping rate, step 430 is implemented of combining at least one undersized batch with regional batches, e.g., batches destined for the same region, of the same shipping method type, e.g., a batch designated for ground shipping or a batch designated for air shipping. Following step 430, implementation of the method 400 transfers to FIG. 4B.

Referring to FIG. 4B, in decision step 432, it is determined whether the total number of items for all batches is enough to qualify for a discounted shipping rate. If yes, in step 434 for each batch, in conjunction with decision step 436, it is determined whether the batch is the minimum size to qualify for a discounted shipping rate. If no, step 438 includes combining the batch with another regional batch of the same shipping method wherein the other batch has a shipping code that is linked to the shipping code of the initial or prior batch such that the resulting combined batch will qualify for a lower grade quantity discounted shipping rate. Decision step 440 is then implemented of determining if the new or succeeding larger batch is at least the minimum size required for a shipping discount, e.g., a discounted shipping rate. If no, step 438 is repeated of combining the batch with another regional batch as just described until in decision step 440, it is determined that yes the new larger batch is at least the minimum size required for a discounted shipping rate. Decision step 442 is then implemented of determining whether all batches have been checked. If no, in step 434 for each batch, in conjunction with decision step 436, it is again determined whether the batch is the minimum size to qualify for a discounted shipping rate.

Returning to decision step 436, if it is determined that that the batch is the minimum size to qualify for a discounted shipping rate, decision step 442 is implemented of determining if all batches have been checked.

If in decision step 442 it is ultimately determined that all batches have been checked, step 444 is implemented of sorting each final batch by neighborhood and then by shipping address to optimize, or reduce as compared to an undiscounted shipping rate, handling costs and delivery mileage prior to transfer to the shipping company.

Returning to decision step 432, if it is determined that the total number of items for all batches is not enough to qualify for a discounted shipping rate, step 446 is implemented of selecting non-discounted shipping for all batches. Following step 446, step 444 is implemented as described above of sorting each final batch by neighborhood and then by shipping address. Following completion of step 444, the method 400 again transfers to FIG. 4.

Referring to FIG. 4, following completion of step 444, referring again to decision step 428, wherein it is determined that the batch that has been split in step 426 into smaller batches segmented by shipping code is the minimum size to qualify for discounted shipping, step 448 for each resulting batch from step 428 and/or step 444 is implemented in conjunction with step 450 of calculating and storing the individual shipping distances between each printer 106 and each batch item 120 destination, or delivery distance from the printer 106 to the destination address of end recipient 104. Step 452 then includes using the shipping distance and shipping method of each item 120 to calculate and store to the processor 110 the energy required to create and/print, and/or ship each item 120.

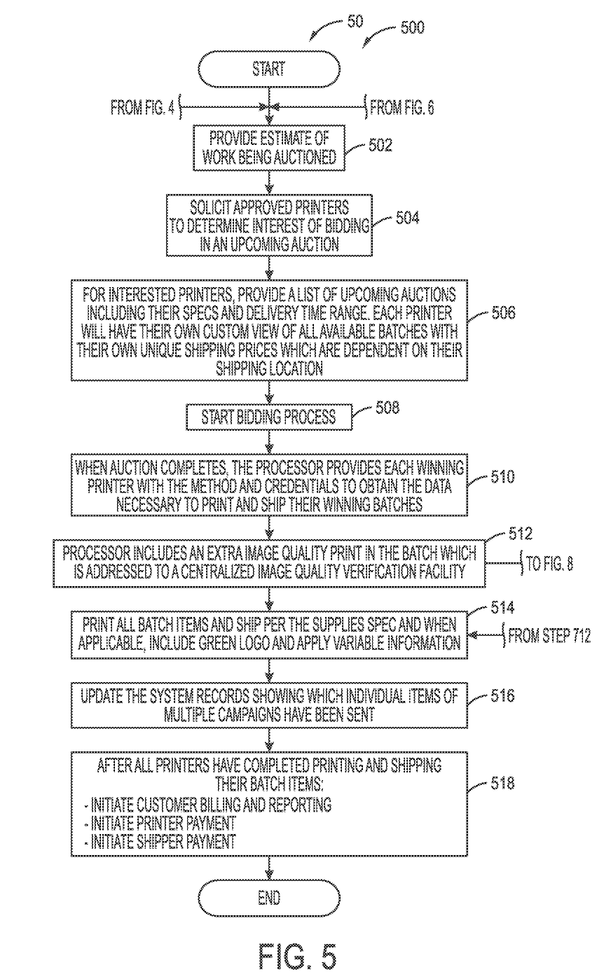

Step 454 includes calculating and storing to the processor 110 the shipping costs for all registered, i.e., approved or credentialed, printers 106 by summing the individual shipping costs between the address of the printers 106 and the shipping location or destination. Step 456 includes assigning the batch to the printer auction list. In decision step 458, it is determined whether all shipping method batches are complete, e.g., batches designated for ground shipping and/or batches designated for air shipping. If no, method 400 returns to repeat decision step 424 as described above until it is determined in decision step 458 that all shipping method batches are complete. Once all shipping method batches are complete, method 400 transfers to FIG. 5, step 502 to start the bidding process.

Referring now to FIG. 5, there is illustrated one embodiment of a method 500 of bidding for and fulfilling printing campaigns during implementation of the method 50 of printing a personalized campaign and optimizing and/or facilitating shipping/delivery of the printed campaign in accordance with the present disclosure. More particularly, following completion of the method 400 of campaign merging and segmentation in FIGS. 4 and 4A, method 50 transfers to step 502 of providing an estimate of campaign jobs or work being auctioned.

Step 504 includes soliciting approved bidders, either manually or by the processor 110, to determine interest in bidding in an upcoming auction for a campaign request or work order.

For interested bidders, i.e., some or all of the plurality of users 106 performing a printing function, step 506 includes, either manually or by the processor 110, providing a list of upcoming auctions including their specifications and delivery time range.

Either manually or by the by processor 110, step 508 includes starting the bidding process. When the bidding or auction process is completed, step 510 includes the processor 110 providing each winning printer 106 with the method and credentials to obtain the data necessary to print and ship the winning batches. Within the batches of each winning printer, step 512 includes the processor 110 including an extra print image for quality assurance purposes that is addressed to a centralized image quality verification facility. The details of the quality assurance process are described below with respect to FIG. 8.

Step 514 includes the winning printer or printers 106 printing all batch items, and when applicable generating green logo 132 and/or green logo 132′ and including green logo 132 and/or 132′ fixed data on campaign item 120 and applying green logo 132 and/or 132′ variable data or information (in conjunction with step 712 in FIG. 7, see also FIGS. 9 and 10, discussed below), and shipping the batch items in accordance with the job specification supplied prior to the bidding process. Step 516 includes updating the system records to show which individual items of multiple campaigns have been sent. After all winning printers 106 have completed printing and shipping their batch items, e.g., campaign cards 120, step 518 includes either manually or the processor initiating billing and reporting to customers 102, initiating payment of printers 106, and initiating payment of the operator(s) of the shipping facility (or facilities) 140, i.e., the one or more users 142 performing transporting functions.

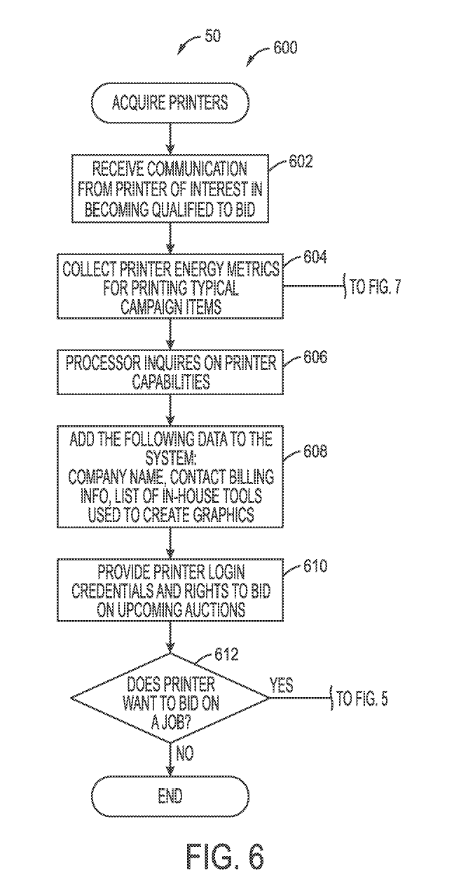

FIG. 6 illustrates one embodiment of a method 600 of acquiring a plurality of users performing printing functions during implementation of the method 50 of printing a personalized campaign and optimizing and/or facilitating shipping/delivery of the printed campaign in accordance with the present disclosure. More particularly, method 600 includes step 602 of either manually or by the processor 110 receiving a communication from one or more of the plurality of printers 106 of interest in becoming qualified to bid on a campaign print job.

Step 604 includes collecting for the particular printer 106 energy metrics for printing typical campaign items. This process is described in detail below with respect to FIG. 7. Step 606 includes either manually or the processor 110 inquiring on the capabilities of the particular printer 106. Step 608 includes either manually or the processor 110 adding data to the memory of the processor 110, for example, but not limited to, the name of the printing company, contact information, billing information, and a list of in-house tools used to create and format graphics. Step 610 includes either manually or the processor 110 providing login credentials and rights for the particular printer 106 to bid on upcoming auctions.

Once the particular printer 106 is given rights to bid on upcoming auctions, decision step 612 includes asking if the particular printer 106 wants to bid on a current or future campaign print job. If yes, the method 600 transfers to method 500 illustrated in FIG. 5 for bidding for and fulfilling printing campaigns. If no, method 60 ends until such time as the particular printer 106 wants to bid on a campaign print job.

FIG. 7 illustrates one embodiment of a method 700 of quantifying a carbon footprint and applying a green or energy logo during implementation of the method 50 of printing a personalized campaign and optimizing and/or facilitating shipment/delivery of the printed campaign in accordance with the present disclosure. More particularly, method 700 includes step 702 of determining which print campaign jobs have been designated for, or require application of, a green or energy logo to the separate personalized campaign cards 120 that are shipped to the plurality of end recipients 104. Step 702 interfaces with step 304 in FIG. 3 wherein it is determined that an energy usage logo is to be applied to all campaign cards 120. Step 704 includes determining which printers 106 have won auctions for each batch location and obtaining the average energy usage of the particular printers 106 to print and ship the personalized campaign cards 120. Step 704 interfaces with step 604 of FIG. 6 wherein energy metrics are collected for the particular printer 106 to print and ship typical personalized campaign cards 120.

Step 706 includes obtaining the individual shipping addresses for the plurality of end recipients 104 for each campaign for which a green logo 132 is to be applied to all or some of the personalized campaign cards 120.

For items within batches that are designated for inclusion of a green or energy logo 132, step 708 includes quantifying the carbon or energy footprint by: (1) calculating a printing energy footprint by estimating the per campaign card 120 energy usage of the printing process multiplied by the carbon conversion factor, e.g., the weight equivalent of carbon dioxide produced or saved; (2) calculating a shipping energy footprint by estimating the per campaign card 120 energy usage of the shipping operation by calculating the flight distance and/or drive distance of a particular batch multiplied by the rate of fuel consumed or used multiplied by the carbon conversion factor; and (3) adding (1) the printing energy footprint plus (2) the shipping energy footprint to quantify the carbon or energy footprint for the particular portion of the campaign for which the green or energy logo 132 is to be applied. Although indicated in Step 708 as being the sum of (1) the printing energy footprint plus (2) the shipping energy footprint, in one embodiment, the carbon or energy footprint may be (1) the printing energy footprint.

Alternatively, in one embodiment, the carbon or energy footprint may be (2) the shipping energy footprint.

Step 710 includes, for each batch shipping location, either manually or by the processor 110 saving the shipping distance and the carbon footprint value (or energy consumption data or rating) per campaign card 120 to the processor memory (not shown in FIG. 1), either the total carbon footprint value calculated by adding (1) plus (2) as described above for step 708 or as indicated alternatively as (1) the printing energy footprint or (2) the shipping energy footprint. The shipping distance is the distance from the location of the printer 106 to the location of the particular end recipient 104 to whom the particular campaign card 120 is to be shipped or delivered. Step 712 includes, for items, e.g., campaign cards 120, for which a green or energy logo 132 and/or 132′ (see discussion below for FIGS. 9 and 10) was requested, the printer 106 generating the green logo 132 or 132′, including the logo 132 and/or 132′ on the campaign card 120, and applying the variable data such as, for example, the shipping distance and specific carbon footprint value represented by the logo to the individual campaign cards 120. Step 710 is implemented in conjunction with step 514 of printing all batch items, and when applicable generating and including green logo 132 and/or 132′ and applying the variable data to green logo 132 and/or 132′, and shipping per the supplied specification, as illustrated and discussed above with respect to FIG. 5. The generating and including the green logo 132 or 132′ and including of the variable data is described below with respect to FIGS. 9 and 10.

FIG. 8 illustrates one embodiment of a method 800 of implementing quality assurance during implementation of the method 50 of printing a personalized campaign and optimizing and/or facilitating shipment/delivery of the printed campaign in accordance with the present disclosure. More particularly, method 800 includes step 802 of accumulating all incoming image quality verification prints. Step 802 is a transfer step from step 512 in FIG. 5 and is implemented either manually at quality verification facility 150 or by quality verification processor 150 (see discussion above with respect to FIG. 1) and includes quantifying different image quality parameters for each printed item, e.g., campaign card 120 and/or green logo 132. Step 806 includes notifying the processor 110 which items, e.g., campaign cards 120, have arrived and storing their quality metrics to the processor 110.

Following step 806, in decision step 808, it is determined whether the quality is acceptable. If yes, the method 800 transfers to decision step 810 in which it is determined whether all quality assurance items have arrived.

Returning to decision step 808, if the quality is not acceptable, step 812 is implemented of notifying the printer(s) 106 of the poor or unacceptable quality level. Step 814 is then implemented of considering having the particular printer(s) 106 who have provided a poor quality batch re-do the batch. Following step 814, in decision step 816 it is determined whether the quality of the particular printer(s) 106 is consistently unacceptable. If yes, step 818 of notifying the particular printer(s) 106 that they will not be able to participate in future auctions. Returning to decision step 816, if it is determined that the quality of the particular printer(s) 106 is not consistently unacceptable, the method 800 transfers to decision step 810. In decision step 810, it is determined whether all quality assurance items, e. g., the incoming quality verification image prints, have arrived If yes, step 822 is implemented of providing the quality level data to customers 102 as they add a new campaign.

Returning to decision step 810, if it is determined that all quality assurance items have not arrived, step 820 is implemented of notifying the printer(s) 106 if the missing items and verifying that their items have been sent. Step 822 is then implemented of providing the quality level data to customers 102 as they add a new campaign.

Step 824 may be implemented of removing the login credentials of printer(s) with poor quality levels to prevent them from participating in future auctions until or unless they have been re-certified to perform at an acceptable quality level.

Method 800 is coordinated with step 512 in FIG. 5 of the optimization processor 110 and/or the quality verification facility or processor 150 receiving one or more extra image quality prints.

Referring to FIGS. 9 and 10, in conjunction with FIGS. 1 and 7, there is illustrated in FIG. 9 a first side 902 of a campaign item, e.g., campaign card 120. Card graphics 910 includes a “Part 1” or first part of printed text and graphical designs 910′ that are fixed, e.g., do not vary from one campaign card 120 to another. Such text and graphical designs 910′ (designated as “CARD”) may include, for example, the name and address of the sender and/or a logo representing the sender, e.g., a client of at least one of the plurality of system users 102 that may be multiple advertising agencies. Alternatively, the sender may be the direct beneficiary of the advertising campaign. In the example illustrated in FIGS. 9 and 10, the sender, and thus at least one of the plurality of system users 102, may be a car dealership that is offering the product(s), and/or good(s) and/or service(s) being advertised via the personalized campaign item 120. Card variable data 920 include a “Part 2” or second part of data that may vary from one campaign card to another. Such variable data 920 may include the name 920a (designated as “TO ANY CUSTOMER”) and shipping address 920b (designated as “GREEN LOGO”) of at least one of the plurality of end recipients 104. The shipping charges or category 920c may also appear on the first side 902 of the campaign card 120.

In one embodiment according to the present disclosure, the first side 902 of the campaign card 120 includes the green or energy logo 132. The green logo 132 may include a “Part 3” or third part of text and/or graphical designs 930 on the first side 902 that are fixed, e.g., do not vary from one campaign card 120 to another. The text and/or graphical designs 930 may include a description of the environmental or energy impact of the process of printing and shipping the particular campaign card 120. Additionally, the green logo 132 may include a “Part 4” or fourth part of variable data 940 that may vary from one campaign card 120 to another. The variable data 940 may include particular numerical data values related to the green or energy logo 132, e.g., a shipping distance from the printer of the campaign card 120 to the shipping address of the end recipient 104 and a “Carbon footprint” value of the quantity of greenhouse gases emitted during the production and/or disposal of the campaign card 120, e.g., the weight or volume of carbon dioxide CO₂ and/or methane CH₄, as examples of greenhouse gases.

As can be appreciated, the amount of text, graphical designs and data related to the green logo 132 may be more suitable to be placed on another location of the campaign card 120. More particularly, referring to FIG. 10, there is illustrated a second side 1002 of the campaign card 120. In a similar manner as with respect to the first side 902, card graphics 1010 includes a “Part 1” or first part of printed text and graphical designs 1010′ that are fixed, e.g., do not vary from one campaign card 120 to another. The first part 1010′ of printed text and graphical designs may include the name 1010′a of the sender, e.g., “EXAMPLE CAR DEALERSHIP SERVICE DEPARTMENT” and/or a graphical design, e.g., a car 1010′b. The graphical design may be variable, e.g., on one campaign card 120, a red car may be shown, whereas in another campaign card, a blue truck may be shown, depending on the personalized information associated with the end recipient 104. General wording 1010′c directed to the end recipient 104 may include variable data. For example, general wording 1010′c may state “Hello ______, It's oil change time for your ______. Bring this card in for a ______ discount”. Variable data 1020 may include the name 1020a of the recipient, e.g., “Nick”, the object or person to whom a service or product is being directed, e.g., type of vehicle “red car” (shown) or “blue truck”, for example, and a reward or a monetary discount 1020c or the like, e.g., “$1.00” as an incentive to respond to the campaign request.

In one embodiment, the second side 1002 includes green or energy logo 132′. In a similar manner as with respect to green or energy logo 132, the green logo 132′ may include a “Part 3” or third part of text and/or graphical designs 1030 on the second side of the card 120 that are fixed, e.g., do not vary from one card to another. The text and/or graphical designs 1030 may include a description of the environmental or energy impact of the process of printing and/or shipping the particular campaign card 120. The text and/or graphical designs 1030 that are fixed may state, for example: “Using our new Green Contact process, this card was created with ______ and printed just ______ from you with a total Carbon Footprint on only ______. You can modify the way we contact you and get more information on this process at: ______”. The green logo 132′ may also include a “Part 4” or fourth part of text and/or graphical designs 1040 that may vary from one campaign card 120 to another. The variable data 1040 may include data such as the type of paper or other material 1040a, e.g., recycled cardboard or other suitable printing material, that the card 120 was created with, e.g., “low cellulose paper”, the shipping distance or delivery distance 1040b from the printer 106 to the end recipient 104, e.g., how many kilometers or miles (23 miles is shown in FIG. 10). The variable data 1040 may also include a carbon footprint value 1040c of the weight in, for example, grams kilograms or pounds or volume in liters, cubic centimeters, cubic inches or the like, of one or more greenhouse gases that have been produced to create (and/or dispose of) the campaign card, e.g., “0.11 Lbs. CO₂” (pounds) is shown. The greenhouse gases may include carbon dioxide (CO₂), methane (CH₄) or other contributors to the green house effect. In addition, the variable data 1040 may include a website address 1040d, e.g. “www.greenblabla.com/Nick” as shown, where the end recipient 104 may access additional information related to the Green Contact process such as how energy efficiency has been enhanced and impact on the environment has been reduced by operation of system 100 for personalized campaign printing and delivery of a printed campaign and implementation of the method 50 of personalized campaign printing and delivery of a printed campaign. The website corresponding to the website address 1040d may be a personalized website that provides information on the carbon footprint value as determined for the particular end recipient 104, in this case “Nick”, and as based on the shipping distance from the particular printer 106 to the particular end recipient 104.

In one embodiment of the present disclosure, referring again to FIGS. 1 and 3, step 304, in conjunction with FIGS. 9 and 10, when the sender, and thus at least one of the plurality of system users 102, is the direct beneficiary of the advertising campaign, as described above, such as a car dealership that is offering the product(s), and/or good(s) and/or service(s) being advertised via the personalized campaign item 120, the graphic materials applicable to the personalized campaign item 120 can be created by the particular user 102 accessing a website that has been established to enable the user to create his or her own campaign item(s) 120 using stock or pre-established and stored graphic materials. The particular user 102 may then upload a list of the intended recipients 104 and the date range within which the campaign item(s) 120 is/are to be shipped by at least one of a plurality of users performing transporting functions, e.g., multiple shippers 142, to deliver at least one of the plurality of personalized campaign items 120 to at least one of the plurality of end recipients 104. The particular user 102 may then provide payment which is recorded by the processor 110. The particular user 102 may request that his or her advertising campaign become part of a current auction as per step 316, or request that the advertising campaign be scheduled as a future auction. The particular user 102 may also request receipt of an email confirmation when the campaign items 120 have been shipped from the shipping facility 140.

Thus, referring to FIG. 1, in conjunction with FIGS. 7, 9 and 10, the processor 110 signals instructions to system 100 to generate a green logo 132 or 132′. The processor 110 further signals instructions to include the green logo 132 or 132′ on the campaign item 120 with the fixed data 930 or 1030, respectively, and to apply the variable data 940 or 1040 to the green logo 132 or 132′, respectively, wherein the variable data 940 or 1040 is indicative of at least the shipping distance and the categorization of the carbon footprint of the campaign item, e.g., card 120.

It can be appreciated from the foregoing disclosure that the system 100 for personalized printing and delivery of a printed campaign enables more energy efficient printing of the printed campaign, and thus a reduced carbon footprint, due to the increase in utilization of local printers as compared to the prior art, due to the more precise identification of shipping destinations by shipping code and segmenting of the batches according to the multiple levels of discounted shipping rates available. The multiple print shops compete for individual segments of print volume and to provide reduced shipping costs in a reverse auction format or process.

As a result, the system 100 also reduces, for personalized printing and delivery of a printed campaign, the printing and shipping costs proportionally for smaller customers.

Correspondingly, the method 50 of personalized campaign printing and delivery of a printed campaign also enables more energy efficient printing of the printed campaign, and thus a reduced carbon footprint, due to the increase in utilization of local printers as compared to the prior art, due to the more precise identification of shipping destinations by shipping code and segmenting of the batches according to the multiple levels of discounted shipping rates available. The multiple print shops compete for individual segments of print volume and to provide reduced shipping costs in a reverse auction format or process.

Thereby, the method 50 also reduces, for personalized printing and delivery of a printed campaign, the printing and shipping costs proportionally for smaller customers.

It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

1. A computer-implemented method of facilitating printing and delivery of an advertising campaign, the method comprising:
receiving, at a central processing entity, an electronic request, through a computer network, from an advertising entity to facilitate printing and delivery of an advertising campaign;
determining, by a processor, a plurality of vendors registered with the central processing entity to bid on advertising campaigns;
receiving a plurality of bids from the plurality of vendors to service one or more segments of the advertising campaign, wherein servicing one or more segments of the advertising campaign comprises printing and mailing copies of one or more mailing items; and
selecting one or more vendors to service the one or more segments of the advertising campaign based on the plurality of bids.

2. The method of claim 1, wherein selecting one or more vendors to service the one or more segments of the advertising campaign comprises:
selecting a vendor associated with a lowest bid for a segment of the advertising campaign at a close of a bidding period.

3. The method of claim 1, wherein selecting one or more vendors to service the one or more segments of the advertising campaign comprises:
excluding vendors that have been identified by the advertising entity for exclusion.

4. The method of claim 1, further comprising:
receiving a maximum price from the advertising entity; and
selecting one or more vendors to service the one or more segments of the advertising campaign only from among vendors providing bids that do not exceed the maximum price.

5. The method of claim 1, wherein the request from the advertising entity comprises specifications about the one or more mailing items, including:
a plurality of addresses corresponding to end recipients to which the one or more mailing items are to be sent; and
a delivery date range within which the end recipients must receive the one or more mailing items.

6. The method of claim 1, further comprising:
dividing the advertising campaign into a plurality of segments in a manner that achieves a maximum discounted shipping rate.

7. The method of claim 1, wherein selecting one or more vendors to service the one or more segments further comprises:
sending specification data to the one or more vendors, wherein the specification data comprises data sufficient to enable the one or more vendors to print and deliver the one or more mailing items.

8. The method of claim 7, further comprising:
providing the one or more vendors with login credentials to the central processing entity to enable the one or more vendors to obtain the specification data.

9. The method of claim 7, wherein the specification data comprises an instruction to print and deliver a test mailing item to a campaign quality verification facility, and wherein the method further comprises:
receiving the test mailing item at the campaign quality verification facility; and
determining quality information about the one or more vendors based on characteristics of the received test mailing item.

10. The method of claim 9, wherein the test mailing item includes:
a test image; and
graphical information sufficient to identify the advertising campaign through a scanning operation.

11. The method of claim 7, wherein the specification data comprises instructions for the one or more vendors to print an indication on the one or more mailing items of an amount of energy used by the one or more vendors to print and deliver the one or more mailing items.

12. The method of claim 1, further comprising:
providing a list of upcoming auctions to the plurality of vendors through the central processing entity.

13. The method of claim 12, wherein the list of upcoming auctions comprises information indicating specifications and delivery time ranges associated with a plurality of advertising campaigns.

14. A system for facilitating printing and delivery of an advertising campaign, the method comprising:
a processing system comprising one or more processors; and
a memory system comprising one or more computer-readable media, wherein the computer-readable media store instructions that, when executed by the processing system, cause the processing system to perform operations comprising:
receiving, at a central processing entity, a request from an advertising entity to facilitate printing and delivery of an advertising campaign;
determining a plurality of vendors registered with the central processing entity to bid on advertising campaigns;
receiving a plurality of bids from the plurality of vendors to service one or more segments of the advertising campaign, wherein servicing one or more segments of the advertising campaign comprises printing and mailing copies of one or more mailing items; and
selecting one or more vendors to service the one or more segments of the advertising campaign based on the plurality of bids.

15. The system of claim 14, wherein selecting one or more vendors to service the one or more segments of the advertising campaign comprises:
selecting a vendor associated with a lowest bid for a segment of the advertising campaign at a close of a bidding period.

16. The system of claim 14, wherein selecting one or more vendors to service the one or more segments of the advertising campaign comprises:
excluding vendors that have been identified by the advertising entity for exclusion.

17. The system of claim 14, the operations further comprising:
receiving a maximum price from the advertising entity; and
selecting one or more vendors to service the one or more segments of the advertising campaign only from among vendors providing bids that do not exceed the maximum price.

18. The system of claim 14, wherein the request from the advertising entity comprises specifications about the one or more mailing items, including:
a plurality of addresses corresponding to end recipients to which the one or more mailing items are to be sent; and
a delivery date range within which the end recipients must receive the one or more mailing items.

19. The system of claim 14, the operations further comprising:
dividing the advertising campaign into a plurality of segments in a manner that achieves a maximum discounted shipping rate.

20. The system of claim 14, wherein selecting one or more vendors to service the one or more segments further comprises:
sending specification data to the one or more vendors, wherein the specification data comprises data sufficient to enable the one or more vendors to print and deliver the one or more mailing items.

21. The system of claim 20, the operations further comprising:
providing the one or more vendors with login credentials to the central processing entity to enable the one or more vendors to obtain the specification data.

22. The system of claim 20, wherein the specification data comprises an instruction to print and deliver a test mailing item to a campaign quality verification facility, and wherein the operations further comprise:
receiving the test mailing item at the campaign quality verification facility; and
determining quality information about the one or more vendors based on characteristics of the received test mailing item.

23. The system of claim 22, wherein the test mailing item includes:
a test image; and
graphical information sufficient to identify the advertising campaign through a scanning operation.

24. The system of claim 20, wherein the specification data comprises instructions for the one or more vendors to print an indication on the one or more mailing items of an amount of energy used by the one or more vendors to print and deliver the one or more mailing items.

25. The system of claim 14, further comprising:
providing a list of upcoming auctions to the plurality of vendors through the central processing entity.

26. The system of claim 25, wherein the list of upcoming auctions comprises information indicating specifications and delivery time ranges associated with a plurality of advertising campaigns.
